(19) United States
(12) Patent Application Publication
(10) Pub. No.: US 2025/0283729 A1
(43) Pub. Date: Sep. 11, 2025

(54) INFORMATION PROCESSING DEVICE, CONTENT PROVIDING METHOD, VEHICLE, AND PROGRAM

(71) Applicant: TOYOTA BOSHOKU KABUSHIKI KAISHA, Aichi (JP)

(72) Inventors: Osamu KAWASE, Aichi (JP); Nobuki HAYASHI, Aichi (JP); Yuki KAMIYA, Aichi (JP); Hiroki ASHIZAWA, Aichi (JP); Tetsuro SAKAGUCHI, Aichi (JP); Tomonori ISHIKAWA, Aichi (JP)

(73) Assignee: TOYOTA BOSHOKU KABUSHIKI KAISHA, Aichi (JP)

(21) Appl. No.: 19/016,526

(22) Filed: Jan. 10, 2025

(30) Foreign Application Priority Data
Mar. 8, 2024 (JP) 2024-036167

(51) Int. Cl. G01C 21/36

(52) U.S. Cl. CPC G01C 21/3655; G01C 21/3644

(57) ABSTRACT

An information processing device includes: a setting section configured to set, in a route, a provision start point at which provision of content is started; a factor information obtaining section configured to obtain, while a traveling body is traveling along the route, factor information about a factor which gives an influence on time when the traveling body arrives at the provision start point; and an adjusting section configured to adjust, while the traveling body is traveling along the route, the provision start point on the basis of the factor information.

This Nonprovisional application claims priority under 35 U.S.C. § 119 on Patent Application No. 2024-036167 filed in Japan on Mar. 8, 2024, the entire contents of which are hereby incorporated by reference.

### TECHNICAL FIELD

The present disclosure relates to an information processing device, a content providing method, a vehicle, and a program.

### BACKGROUND ART

Patent Literature 1 discloses a content distribution system for providing, to a passenger in a traveling body, content according to a destination when the passenger travels to the destination.

### CITATION LIST

### Patent Literature

### [Patent Literature 1]

International Publication No. WO 2023/058501

### SUMMARY OF INVENTION

### Technical Problem

For providing content while a traveling body is traveling, a timing to provide the content is sometimes important. For example, even when content is provided to a passenger after a traveling body has passed through a place relating to the content, an effect aimed by the content may not be attained.

Time when a traveling body arrives at a given position may sometimes become earlier or later than scheduled time depending on various factors. For example, in cases of vehicles such as automobiles, buses, and taxies, it is considered that the time may become earlier or later than scheduled time due to a factor(s) such as a road condition and/or weather. In cases of buses, railroad trains, aircrafts, ships, and the like, it is considered that the time may become earlier or later than schedule time due to a factor(s) such as occurrence of an accident causing injury or death.

An aspect of the present disclosure has an object to provide content to a passenger of a traveling body at a targeted timing.

### Solution to Problem

In order to attain the above object, an information processing device in accordance with an aspect of the present disclosure is an information processing device that provides content to a passenger of a traveling body traveling along a route, the information processing device including: a setting section configured to set, in the route, a provision start point where provision of the content is started; a factor information obtaining section configured to obtain, while the traveling body is traveling along the route, factor information about a factor that gives an influence on time when the traveling body arrives at the provision start point; and an adjusting section configured to adjust, while the traveling body is traveling along the route, the provision start point on a basis of the factor information.

In order to attain the above object, a content providing method in accordance with another aspect of the present disclosure is a content providing method for controlling an output device to provide content to a passenger of a traveling body traveling along a route, the content providing method including the steps of: setting, in the route, a provision start point where provision of the content is started; obtaining, while the traveling body is traveling along the route, factor information about a factor that gives an influence on time when the traveling body arrives at the provision start point; and adjusting, while the traveling body is traveling along the route, the provision start point on a basis of the factor information.

An information processing device in accordance with each aspect of the present disclosure may be realized by a computer. In this case, the present disclosure also encompasses: a program for the information processing device, the program causing a computer to operate as the sections (software elements) included in the information processing device so that the information processing device is realized by the computer; and a computer-readable storage medium in which the program is stored.

### Advantageous Effects of Invention

According to an aspect of the present disclosure, it is possible to provide content to a passenger of a traveling body at a targeted timing.

### BRIEF DESCRIPTION OF DRAWINGS

FIG. 1 is a block diagram illustrating an example of a configuration of a content providing system that uses an information processing device in accordance with an embodiment of the present disclosure.

FIG. 2 is a view illustrating an example of a configuration of the information processing device in accordance with the embodiment of the present disclosure.

FIG. 3 is a view used to explain a setting section and an adjusting section.

FIG. 4 is a flowchart relating to a content providing method in accordance with an embodiment of the present disclosure.

### DESCRIPTION OF EMBODIMENTS

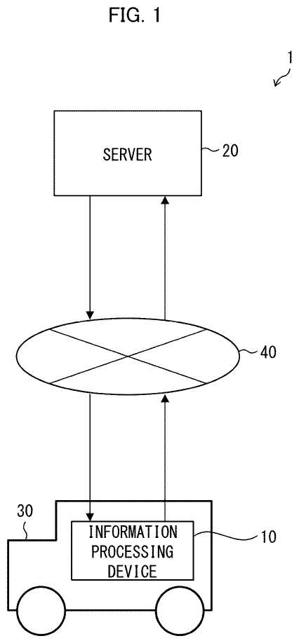

FIG. 1 is a block diagram illustrating an example of a configuration of a content providing system that uses an information processing device in accordance with an embodiment of the present disclosure. A content providing system 1 shown in FIG. 1 includes an information processing device 10 and a server 20. For example, the information processing device 10 is disposed inside a vehicle 30, and provides content to a passenger of the vehicle 30. The vehicle 30 is one example of the traveling body, and is, for example, an automobile, a bus, or a taxi. The content is the one that can be sensed by the passenger with five senses. The content includes a video, an audio, a vibration, an odor, and/or mist, for example.

The server 20 is disposed outside the information processing device 10. The server 20 has a function to transmit, to the information processing device 10, data of the content that the information processing device 10 provides to the passenger. The data of the content includes: guiding content for providing information about (i) a facility existing in an area surrounding a road on which the vehicle 30 travels, (ii) a building that is viewable through a window of the vehicle 30, and/or (iii) a landmark(s) such as a river and/or a mountain; and advertising content for advertisement.

The data relating to the guiding content includes (i) information indicative of a position (a latitude, a longitude, and/or an altitude) of a subject to be guided (i.e., a guiding subject) such as a facility and/or a landmark, (ii) data indicative of a video and/or an audio relating to the guiding subject, and (iii) information about a playback time of a video and/or an audio.

The information processing device 10 and the server 20 are connected to a network 40 such as a wireless communication network, an Internet network, or a telephone line network. For convenience of explanation, FIG. 1 illustrates a single information processing device 10. Alternatively, the content providing system 1 may include a plurality of information processing devices 10. Further, the information processing device 10 and the server 20 may be connected to, via the network 40 and/or the like, an information terminal, a server, and/or the like (not illustrated). For example, the information processing device 10 and the server 20 may be connected to an information terminal possessed by the passenger of the vehicle 30.

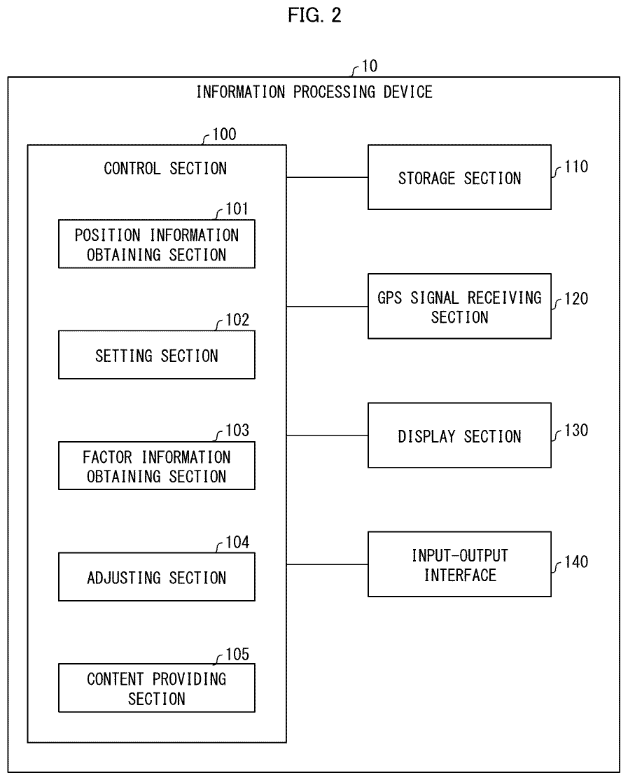

FIG. 2 is a view illustrating an example of a configuration of the information processing device in accordance with the embodiment of the present disclosure. As shown in FIG. 2, the information processing device 10 includes a control section 100, a storage section 110, a GPS signal receiving section 120, a display section 130, and an input-output interface 140.

The control section 100 includes, e.g., a central processing unit (CPU) and a main storage device. The storage section 110 includes, e.g., a hard disk drive (HDD) and/or a solid state drive (SSD). In the storage section 110, a program to be executed by the control section 100 and data of content transmitted from the server 20 are stored.

The GPS signal receiving section 120 receives a signal from a GPS satellite. The display section 130 is one example of the output device, and can be used to provide content such as a still image and/or a moving image. The input-output interface 140 is, for example, a universal serial bus (USB) terminal and/or a local area network (LAN) terminal. The information processing device 10 is connected, via the input-output interface 140, to a vehicle communication network such as a controller area network (CAN). The information processing device 10 is connectable to the network 40 via CAN.

The information processing device 10 can obtain, via the input-output interface 140, route information indicative of a route along which the vehicle 30 is scheduled to travel. For example, the information processing device 10 may obtain, via the network 40, route information that the passenger has registered in the server 20 in advance. Further, the information processing device 10 may be configured such that (i) map data is stored in the storage section 110 and (ii) input of information about a place of departure and a destination from a user, such as a passenger, is accepted by a desired method and searching for a route from the place of departure to the destination is carried out.

The information processing device 10 obtains, from the server 20, data of guiding content and advertisement content to be provided while the vehicle 30 is traveling along the route. In a case where the information processing device 10 obtains the route information from the server 20, the information processing device 10 may obtain, from the server 20, data of the content together with the route information. Further, in a case where the information processing device 10 searches a route, the information processing device 10 may transmit the route information to the server 20 via the network 40 and obtain the data of the content from the server 20.

By executing the program stored in the storage section 110, the control section 100 functions as a position information obtaining section 101, a setting section 102, a factor information obtaining section 103, an adjusting section 104, and a content providing section 105.

The position information obtaining section 101 obtains position information indicative of a current position of the vehicle 30. For example, the position information obtaining section 101 obtains, on the basis of a signal that the GPS signal receiving section 120 has received from a GPS satellite, position information indicative of a current position of the vehicle 30. The position information obtaining section 101 may be connected to CAN via the input-output interface 140 and may be configured to obtain vehicle information about a vehicle speed of the vehicle 30, an acceleration of the vehicle 30, and amounts of operation of an accelerator pedal, a brake pedal, and a steering wheel of the vehicle 30 and to use the vehicle information to calculate the current position of the vehicle 30.

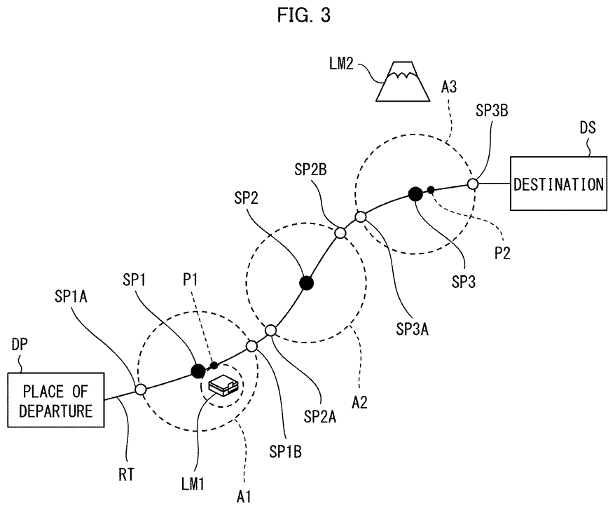

FIG. 3 is a view used to explain the setting section and the adjusting section. FIG. 3 shows, on a route RT from a place of departure DP to a destination DS, positions of provision start points SP1, SP2, and SP3 where provision of content is started. The route RT is a route along which the vehicle 30 is scheduled to travel. Each of the provision start points SP1, SP2, and SP3 is one example of the provision start point.

In FIG. 3, “LM1” indicates (i) a facility that is a guiding subject of the guiding content or (ii) a facility that deals with an advertisement subject of the advertisement content. The facility LM1 is located at an area surrounding the route RT, and a position P1 on the route RT is included within a range of a given distance from the facility LM1. Therefore, data such as guiding content relating to the facility LM1 and advertisement content of an advertisement subject dealt with by the facility LM1 is transmitted from the server 20 to the information processing device 10. The “given distance” herein refers to, for example, a width of a road which is included in the route RT and which is located in an area surrounding the facility LM1.

A provision start point SP1 indicates a position where provision of, e.g., the guiding content relating to the facility LM1 is started. The setting section 102 sets scheduled time of arrival of the vehicle 30 at the provision start point SP1 on the basis of, for example, information indicative of a position of the facility LM1 and information about a playback time of the content. The scheduled time of arrival at the provision start point, which is set by the setting section 102, will be referred to as “first scheduled time”.

In FIG. 3, “LM2” indicates a landmark which is the guiding subject of the guiding content. In an area surrounding a position P2 on the route RT, a landmark LM2 is sometimes viewable through a window of the vehicle 30. Thus, data of guiding content relating to the landmark LM2 is transmitted from the server 20 to the information processing device 10. The provision start point SP3 indicates a position where provision of the guiding content relating to the landmark LM2 is started. The setting section 102 sets first scheduled time when the vehicle 30 arrives at the provision start point SP3, for example, on the basis of information indicative of a position of the landmark LM2 and information about a playback time of the guiding content.

The information processing device 10 starts providing each content at the first scheduled time of the content so as to make the passenger interested in the guiding subject and/or the advertisement subject. However, when the vehicle 30 actually moves along the route RT, time when the vehicle 30 arrives at the provision start point may sometimes become earlier or later than the first scheduled time due to various factors such as a road condition and/or weather.

The adjusting section 104 adjusts a position of the provision start point in consideration of various factors such as a road condition and/or weather that give an influence on the time when the vehicle 30 arrives as the provision start point. A provision area A1 shown in FIG. 3 is a given-distance range centered on the provision start point SP1. The adjusting section 104 adjusts a position where provision of the guiding content relating to the facility LM1 is started so that the position is set within the provision area A1. The “given distance” is 20 m, for example. The “given distance” may vary depending on the provision start point SP1. For example, the given distance may vary depending on a road width, the number of lanes, and/or the like of the provision start point SP1.

In FIG. 3, an outer circumference of the provision area A1 intersects the route RT at two points. A provision start point SP1A is provided at an intersecting point closer to the place of departure DP than the provision start point SP1 is, and a provision start point SP1B is provided at an intersecting point closer to the destination DS than the provision start point SP1 is. For example, in a case where there is a possibility that the vehicle 30 may arrive at the provision start point SP1 earlier than the first scheduled time, the adjusting section 104 adjusts the provision start point SP1 so that the provision start point SP1 is set at the provision start point SP1A. For another example, in a case where there is a possibility that the vehicle 30 may arrive at the provision start point SP1 later than the first scheduled time, the adjusting section 104 adjusts the provision start point SP1 so that the provision start point SP1 is set at the provision start point SP1B.

The adjusting section 104 adjusts a position where provision of the guiding content relating to the landmark LM2 is started so that the position is set within a provision area A3 centered on the provision start point SP3. In FIG. 3, an outer circumference of the provision area A3 intersects the route RT at two points. A provision start point SP3A is provided at an intersecting point closer to the place of departure DP than the provision start point SP3 is, and a provision start point SP3B is provided at an intersecting point closer to the destination DS than the provision start point SP3 is. For example, in a case where there is a possibility that the vehicle 30 may arrive at the provision start point SP3 earlier than the first scheduled time, the adjusting section 104 adjusts the provision start point SP3 so that the provision start point SP3 is set at the provision start point SP3A. For another example, in a case where there is a possibility that the vehicle 30 may arrive at the provision start point SP3 later than the first scheduled time, the adjusting section 104 adjusts the provision start point SP3 so that the provision start point SP3 is set at the provision start point SP3B.

A provision start point SP2 indicates a position where provision of the advertisement content is started. In a case where the route RT includes a partial path for which provision of the content is not scheduled, the setting section 102 sets, on the partial path, the provision start point for the advertisement content. FIG. 3 shows a provision area A2 centered on the provision start point SP2. An outer circumference of the provision area A2 intersects the route RT at two points. A provision start point SP2A is provided at an intersecting point closer to the place of departure DP than the provision start point SP2 is, and a provision start point SP2B is provided at an intersecting point closer to the destination DS than the provision start point SP2 is. For example, in a case where there is a possibility that the vehicle 30 may arrive at the provision start point SP2 earlier than the first scheduled time, the adjusting section 104 adjusts the provision start point SP2 so that the provision start point SP2 is set at the provision start point SP2A. For another example, in a case where there is a possibility that the vehicle 30 may arrive at the provision start point SP2 later than the first scheduled time, the adjusting section 104 adjusts the provision start point SP2 so that the provision start point SP2 is set at the provision start point SP2B.

While the vehicle 30 is traveling along the route RT, the factor information obtaining section 103 shown in FIG. 2 obtains factor information about (i) a factor that gives an influence on time when the vehicle 30 arrives at the provision start point SP1 or the like and (ii) a factor that causes the time when the vehicle 30 arrives at the provision start point to become earlier or later than the first scheduled time.

For example, with regard to the position of the vehicle 30 obtained by the position information obtaining section 101, the factor information obtaining section 103 may obtain, as the factor information, a difference between scheduled arrival time and actual arrival time. For example, in a case where the actual arrival time is earlier than the scheduled arrival time by not less than a given period of time, the difference between the scheduled arrival time and the actual arrival time serves as factor information indicative of a factor that causes time when the vehicle 30 arrives at the provision start point to become earlier than the first scheduled time. In a case where the actual arrival time is later than the scheduled arrival time for not less than a given period of time, the difference between the scheduled arrival time and the actual arrival time serves as factor information indicative of a factor that causes the time when the vehicle 30 arrives at the provision start point becomes later than the first scheduled time.

Further, the factor information obtaining section 103 may access, via network 40, a web service that provides information about a road condition and/or weather and may obtain, as the factor information, information about a road condition and/or weather of an area surrounding the provision start point.

When the current position of the vehicle 30 obtained by the position information obtaining section 101 reaches the provision start point set by the adjusting section 104, the content providing section 105 provides content corresponding to the provision start point. For example, in a case where the content is a video, the content providing section 105 plays back the video via the display section 130 of the information processing device 10. The content providing section 105 may play back the video via the display section provided in the vehicle 30 and/or an information terminal possessed by the passenger on the vehicle 30.

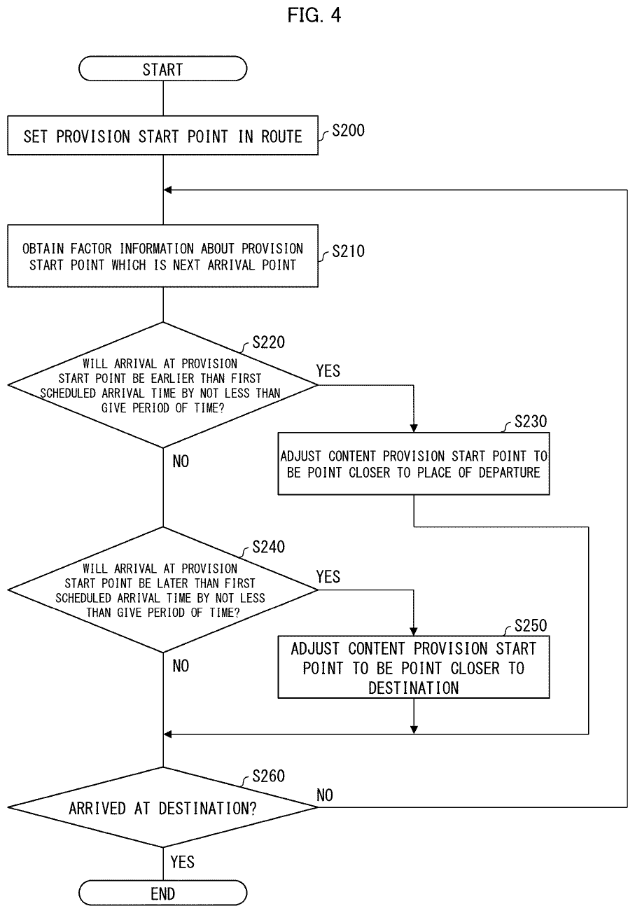

FIG. 4 is a flowchart relating to a content providing method in accordance with an embodiment of the present disclosure. The process shown in FIG. 4 is executed by the control section 100 while the vehicle 30 is traveling along the route. In the description below, it is assumed that the vehicle 30 is traveling along the route RT shown in FIG. 3.

In S200, the control section 100 functions as the setting section 102 to set, in a route along which the vehicle 30 is scheduled to travel, a provision start point where provision of content is started. For example, as shown in FIG. 3, the control section 100 sets, in the route RT along which the vehicle 30 is scheduled to travel, the provision start points SP1, SP2, and SP3 where provision of content is started.

In subsequent S210, the control section 100 obtains factor information about a provision start point at which the vehicle 30 will arrive at next. For example, in a case where the vehicle 30 is traveling in an area near the place of departure DP, the control section 100 obtains factor information about the provision start point SP1, at which the vehicle 30 will arrive at next.

In S220, the control section 100 determines, on the basis of the factor information obtained in S210, whether or not the vehicle 30 will arrive at the provision start point SP1 at an earlier timing. For example, in a case where, with regard to the position of the vehicle 30 obtained by the position information obtaining section 101, actual arrival time is earlier than scheduled arrival time by not less than a given period of time, the control section 100 determines that the vehicle 30 will arrive at the provision start point SP1 at an earlier timing (S220: YES), and adjusts the provision start point SP1 for the content so that the provision start point SP1 is set at the provision start point SP1A, which is located closer to the place of departure DP (S230). Meanwhile, in a case where, with regard to the position of the vehicle 30 obtained by the position information obtaining section 101, the actual arrival time is not earlier than the scheduled arrival time by not less than a given period of time (S220: NO), the control section 100 advances to a process in S240.

In S240, on the basis of the factor information obtained in S210, the control section 100 determines whether or not the vehicle 30 will arrive at the provision start point SP1 at a later timing. For example, in a case where, with regard to the position of the vehicle 30 obtained by the position information obtaining section 101, the actual arrival time is later than the scheduled arrival time by not less than the given period of time, the control section 100 determines that the vehicle 30 will arrive at the provision start point SP1 at a later timing (S240: YES), and adjusts the provision start point SP1 for the content so that the provision start point SP1 is set at the provision start point SP1B, which is located closer to the destination DS (S250). In a case where, with regard to the position of the vehicle 30 obtained by the position information obtaining section 101, the actual arrival time is not later than the scheduled arrival time by not less than the given period of time (S240: NO), the control section 100 advances to a process in S260.

In S260, the control section 100 determines whether or not the vehicle 30 has arrived at the destination DS. In a case where the vehicle 30 has arrived at the destination DS (S260: YES), the control section 100 ends the processes shown in FIG. 4. Meanwhile, in a case where the vehicle 30 has not arrived at the destination DS (S260: NO), the control section 100 advances to a process in S210.

### Effects

As explained above, according to the information processing device 10 in accordance with the present embodiment, it is possible to attain the following effects.

The information processing device 10 provides content to the passenger of the vehicle 30 traveling along the route RT, and includes the setting section 102, the factor information obtaining section 103, and the adjusting section 104. The setting section 102 sets, in the route RT, the provision start point SP1 or the like where provision of the content is started. The factor information obtaining section 103 obtains, while the vehicle 30 is traveling along the route RT, factor information about a factor that gives an influence on time when the vehicle 30 arrives at the provision start point SP1 or the like. While the vehicle 30 is traveling along the route RT, the adjusting section 104 adjusts the provision start point SP1 on the basis of the factor information. With the above configuration, the information processing device 10 can provide the content to the passenger of the vehicle 30 at a targeted timing.

In a case where the factor information obtaining section 103 obtains information about a factor that causes the time when the vehicle 30 arrives at the provision start point SP1 or the like to become earlier, the adjusting section 104 adjusts the provision start point SP1 or the like so that the provision start point SP1 or the like is set at a position (e.g., the provision start point SP1A) closer to the place of departure DP in the route RT. In a case where the factor information obtaining section 103 obtains information about a factor that causes the time when the vehicle 30 arrives at the provision start point SP1 or the like to become later, the adjusting section 104 adjusts the provision start point SP1 or the like so that the provision start point SP1 or the like is set at a position (e.g., the provision start point SP1B) closer to the destination DS in the route RT. With the above configuration, the information processing device 10 can provide the content at a timing at which the vehicle 30 can arrive at the provision start point.

The information processing device 10 further includes the position information obtaining section 101 configured to obtain position information indicative of a current position of the vehicle 30. The factor information obtaining section 103 obtain factor information on the basis of a difference between (i) time when the vehicle 30 is scheduled to arrive at the current position and (ii) time when the vehicle 30 actually arrived at the current position, each obtained in a case where the vehicle 30 travels along the route RT. With the above configuration, the vehicle 30 can obtain, through the position information of the vehicle 30 and/or the like, an accurate factor(s) associated with various matters such as a road condition and/or weather.

The content includes content for providing, to the passenger, information about a given guiding subject. The guiding subject includes (i) a subject (e.g., the facility LM1) located within a range of a given distance from the route RT and (ii) a subject (e.g., the landmark LM2) viewable from the route RT. With the above configuration, by providing the content regarding the guiding subject, it is possible to uplift the passenger's mood while the vehicle 30 is traveling along the route RT.

The content providing method shown in FIG. 4 controls the display section 130 to provide the content to the passenger of the vehicle 30 traveling along the route RT. The content providing method includes the steps of: setting, in the route RT, the provision start point SP1 or the like where provision of the content is started (S200); obtaining, while the vehicle 30 is traveling along the route RT, the factor information about a factor that gives an influence on time when the vehicle 30 arrives at the provision start point SP1 or the like (S210); and adjusting, while the vehicle 30 is traveling along the route RT, the provision start point SP1 or the like on the basis of the factor information (S220 to S250). With the above configuration, the content providing method shown in FIG. 4 can provide the content to the passenger of the vehicle 30 at a targeted timing.

The vehicle 30 includes the information processing device 10 and the output device configured to output the content.

### Software Implementation Example

The functions of the information processing device 10 (hereinafter, referred to as a “device”) can be realized by a program for causing a computer to function as the device, the program causing the computer to function as the control blocks (particularly, the sections included in the control section 100) of the device.

In this case, the device includes, as hardware for executing the program, at least one control device (e.g., a processor) and at least one storage device (e.g., a memory). By causing the control device and the storage device to execute the program, the functions explained in the foregoing embodiments are realized.

The program may be recorded in one or more non-transitory computer-readable recording media. The recording media may or may not be included in the device. In the latter case, the program may be supplied to or made available to the device via any wired or wireless transmission medium.

Furthermore, some or all of the functions of the control blocks can also be realized by a logic circuit. For example, the present disclosure encompasses, in its scope, an integrated circuit in which a logic circuit that functions as each of the above-described control blocks is formed. In addition, the function of each of the control blocks can be realized by, for example, a quantum computer.

The processes described in the foregoing embodiments may be carried out by artificial intelligence (AI). In this case, AI may be operated in the control device, or may be operated in another device (e.g., an edge computer or a cloud server).

### Variations

The foregoing embodiment has dealt with the content providing method that provides content while the vehicle 30 is traveling on a road. However, the information processing device and the content providing method in accordance with one embodiment of the present disclosure are applicable to provision of content carried out during traveling of railroad trains, aircrafts, ships, and the like that do not travel on a road.

In the foregoing embodiment, the information processing device 10 is configured such that data of content that is to be provided to a passenger is transmitted from f the server 20 to the information processing device 10. Alternatively, however, the data of the content may be stored in the storage section 110 of the information processing device 10 in advance.

In the foregoing embodiment, the control section 100 of the information processing device 10 provided inside the vehicle 30 functions as the setting section 102, the factor information obtaining section 103, and the adjusting section 104. Alternatively, however, the information processing device including the setting section 102, the factor information obtaining section 103, and the adjusting section 104 may be provided outside the vehicle 30. For example, the server 20 may function as the information processing device. In a case where the server 20 is caused to function as the setting section 102, the factor information obtaining section 103, and the adjusting section 104, (i) position information of the vehicle 30 and/or (ii) vehicle information about a vehicle speed, an acceleration, and/or an amount of operation of an accelerator pedal of the vehicle 30 may be transmitted from the information processing device 10 to the server 20.

### SUPPLEMENTARY REMARKS

The present disclosure is not limited to the embodiments above, but can be altered by a skilled person in the art within the scope of the claims. The present disclosure also encompasses, in its technical scope, any embodiment derived by combining technical means disclosed in differing embodiments as appropriate.

### REFERENCE SIGNS LIST

10: information processing device
20: server
30: vehicle
40: network
100: control section
101: position information obtaining section
102: setting section
103: factor information obtaining section
104: adjusting section
SP1, SP1A, SP1B, SP2, SP2A, SP2B, SP3, SP3A, SP3B: provision start point (provision start point)

1. An information processing device that provides content to a passenger of a traveling body traveling along a route, the information processing device comprising:
a setting section configured to set, in the route, a provision start point where provision of the content is started;
a factor information obtaining section configured to obtain, while the traveling body is traveling along the route, factor information about a factor that gives an influence on time when the traveling body arrives at the provision start point; and
an adjusting section configured to adjust, while the traveling body is traveling along the route, the provision start point on a basis of the factor information.

2. The information processing device according to claim 1, wherein:
in a case where the factor information obtaining section obtains information about a factor that causes the time when the traveling body arrives at the provision start point to become earlier, the adjusting section adjusts the provision start point so that the provision start point is set at a position closer to a place of departure in the route; and
in a case where the factor information obtaining section obtains information about a factor that causes the time when the traveling body arrives at the provision start point to become later, the adjusting section adjusts the provision start point so that the provision start point is set at a position closer to a destination in the route.

3. The information processing device according to claim 1, further comprising:
a position information obtaining section configured to obtain position information indicative of a current position of the traveling body, wherein:
the factor information obtaining section obtains the factor information on a basis of a difference between (i) time when the traveling body is scheduled to arrive at the current position and (ii) time when the traveling body actually arrived at the current position, each obtained in a case where the traveling body travels along the route.

4. The information processing device according to claim 1, wherein:
the content includes content for providing, to the passenger, information about a given guiding subject; and
the given guiding subject includes (i) a subject located within a range of a given distance from the route and (ii) a subject viewable from the route.

5. A content providing method for controlling an output device to provide content to a passenger of a traveling body traveling along a route, the content providing method comprising the steps of:
setting, in the route, a provision start point where provision of the content is started;
obtaining, while the traveling body is traveling along the route, factor information about a factor that gives an influence on time when the traveling body arrives at the provision start point; and
adjusting, while the traveling body is traveling along the route, the provision start point on a basis of the factor information.

6. A vehicle comprising:
an information processing device recited in claim 1; and
an output device configured to output content.

7. A program for causing a computer to function as an information processing device recited in claim 1, the program causing the computer to function as the setting section, the factor information obtaining section, and the adjusting section.
